(19) United States
(12) Patent Application Publication
(10) Pub. No.: US 2025/0145812 A1
(43) Pub. Date: May 8, 2025

(54) IONOMER RESIN COMPOSITION

(71) Applicant: KURARAY AMERICA, INC., Houston, TX (US)

(72) Inventor: Charles SMITH, Houston, TX (US)

(73) Assignee: KURARAY AMERICA, INC., Houston, TX (US)

(21) Appl. No.: 18/865,733

(22) PCT Filed: Jun. 14, 2023
(86) PCT No.: PCT/US2023/025269

§ 371 Date: Nov. 14, 2024

Related U.S. Application Data
(60) Provisional application No. 63/354,307, filed on Jun. 22, 2022.
(60) Provisional application No. 63/354,335, filed on Jun. 22, 2022.

(51) Int. Cl. C08L 23/0876; B29C 48/00; B29C 48/08; B29K 33/00; B29K 96/00; B29K 105/26; B32B 17/10; C09J 7/29; C09J 123/08

(52) U.S. Cl. CPC C08L 23/0876; B29C 48/0021; B29C 48/022; B29C 48/08; B32B 17/10036; B32B 17/1055; C09J 7/29; C09J 123/0876; B29K 2033/00; B29K 2033/12; B29K 2096/005; B29K 2105/26; B32B 2272/00; B32B 2307/412; C08L 2205/02; C08L 2207/20

(57) ABSTRACT

Provided is an ionomer resin composition comprising a sodium-neutralized ethylene acid dipolymer and a sodium-neutralized ethylene acid ester terpolymer, wherein desirably at least one of the dipolymer and terpolymer is in part a recycle material. The described ionomer composition is particularly suited for use in making interlayers and glass laminates comprising such interlayers.

### CROSS-REFERENCE TO RELATED APPLICATIONS

This application claims priority to U.S. Provisional Application Ser. No. 63/354,335 and to U.S. Provisional Application Ser. No. 63/354,307, both filed Jun. 22, 2022, both incorporated herein by reference in their entireties for all purposes as if fully set forth.

### FIELD OF THE INVENTION

The present invention relates to an ionomer resin composition comprising a sodium-neutralized ethylene acid dipolymer and a sodium-neutralized ethylene acid ester terpolymer. The described ionomer composition is particularly suited for use in making interlayers and glass laminates comprising such interlayers.

### BACKGROUND OF THE INVENTION

Laminated glass is generally made by laminating two pieces of glass onto a plastic interlayer. One particular advantage of laminated glass versus solid glass sheets is impact and shatter resistance due to adhesion of the glass to the interlayer sheet.

In safety glass laminates, optimal adhesion of the interlayer to glass is a balance. Too much adhesion detracts from the ability of the laminate to absorb and dissipate energy during an impact event, and too little adhesion can result in optical defects (at the time of lamination and subsequently), and can also detrimentally affect the ability of the interlayer to retain glass shards on impact.

Many different materials have been used as the plastic interlayer. For example, sheets containing a polyvinyl acetal (polyvinyl butyral) and a plasticizer are widely utilized as an interlayer for laminated glass because they have excellent adhesion-to-glass properties. Laminated glass containing such interlayers can be made with good transparency, mechanical strength, flexibility, acoustic damping and shatter resistance.

At least partially neutralized ethylene acid copolymers (ionomers) have also been used as interlayers for preparing laminated safety glass, for example, as disclosed in U.S. Pat. Nos. 3,404,134, 3,344,014, 7,445,683B2, U.S. Pat. No. 7,763,360B2, U.S. Pat. No. 7,951,865B1, U.S. Pat. No. 7,960,017B2, U.S. Pat. No. 8,399,097B2, U.S. Pat. No. 8,399,098B2, US2017/0320297A1 US2018/0117883A1, WO2016/076336A1, WO2016/076337A1, WO2016/076338A1 WO2016/076339A1 and WO2016/076340A1.

It has now been found that by combining a sodium-neutralized ethylene acid dipolymer with a sodium-neutralized ethylene acid ester terpolymer in an ionomer composition, particularly when at least one of the components is partially or wholly a recycle material, beneficial physical properties can be retained in the blend.

As used herein, where the terms “invention, “present invention,” and the like are used they refer only to the particular embodiment immediately following. They are not broadly limiting overall, or with regard to the several advances in the art described herein.

### SUMMARY

The present invention addresses the above-described problems by providing an ionomer resin composition comprising:
(i) from about 1 wt % to about 99 wt % of an at least partially sodium-neutralized ethylene acid dipolymer ionomer resin, and
(ii) from about 1 wt % to about 99 wt % of an at least partially sodium-neutralized ethylene acid ester terpolymer ionomer resin,
wherein the combined wt % of (i) and (ii) is 100 wt %, and wt % is based on the combined weight of (i)+ (ii).

In one embodiment, the sodium-neutralized ethylene acid dipolymer ionomer resin (i) is an at least partially sodium-neutralized ethylene acid dipolymer resin consisting essentially of, or consisting of, copolymerized units of ethylene and at least one α,β-unsaturated carboxylic acid, and the sodium-neutralized ethylene acid ester terpolymer ionomer resin (ii) is an at least partially sodium-neutralized ethylene acid terpolymer resin comprising, consisting essentially of, or consisting of copolymerized units of ethylene, at least one α,β-unsaturated carboxylic acid, at least one α,β-unsaturated carboxylic acid ester and, optionally, a derivative of an α,β-unsaturated carboxylic acid other than an ester, such as an amide or an anhydride.

In one embodiment, one of (i) or (ii) is from about 5 wt % to about 30 wt %, or to about 25 wt %, to about 20 wt %, to about 15 wt %, or to about 10 wt %, based on the combined weight of (i)+(ii). In another embodiment, one of (i) or (ii) is from about 10 wt % to about 30 wt %, or to about 25 wt %, to about 20 wt %, or to about 15 wt %, based on the combined weight of (i)+ (ii). In another embodiment, one of (i) or (ii) is from about 15 wt % to about 30 wt %, or to about 25 wt %, to about 20 wt %, based on the combined weight of (i)+ (ii). In another embodiment, one of (i) or (ii) is from about 20 wt % to about 30 wt %, or to about 25 wt %, based on the combined weight of (i)+ (ii). In another embodiment, one of (i) or (ii) is from about 25 wt % to about 30 wt %, based on the combined weight of (i)+ (ii).

In one embodiment, at least a portion, or a predominant portion, or substantially all, of at least one of (i) and (ii) is a recycle material. In another embodiment, at least a portion, or a predominant portion, or a substantially all, of one of (i) or (ii) is a virgin material. In another embodiment, at least one (or both) of (i) and (ii) is a combination of virgin material and recycle material. In another embodiment, one of (i) or (ii) is substantially (or is) a virgin material, and one of (i) or (ii) is substantially (or is) a recycle material.

In one embodiment, a dialkoxysilane adhesion promoter (iii) is present in the ionomer resin composition in an amount ranging from about 50 to about 5000 parts per million by weight based on the combined weight of the dipolymer and terpolymer ionomer resins.

In another aspect, the present invention provides a method of producing sheets of an ionomer resin composition by melt blending (i), (ii) and optional components under shear to produce a melt blend, then extruding the melt blend through a die into a sheet form, then cooling the sheet form to solidify the resin composition. In one embodiment, the sheet has a top side and a bottom side, and the sheet is embossed with a pattern on one or both of the top and bottom sides prior to solidification.

In other aspects, the present invention provides an interlayer sheet of such resin composition, and a glass laminate made from such interlayer sheet, for example, comprising two sheets of glass having interposed between an interlayer in accordance with the present invention.

These and other embodiments, all of which can be used in combination, describe features and advantages of the present invention that will be more readily understood by those of ordinary skill in the art from a reading of the following detailed description.

### DETAILED DESCRIPTION

The present invention relates, without limitation, to resin compositions, interlayers prepared from such resin compositions, and a glass laminate containing such interlayers. Further embodiments and details are provided below.

All publications, patent applications, patents and other references mentioned herein, if not otherwise indicated, are explicitly incorporated by reference herein in their entirety for all purposes as if fully set forth.

Unless otherwise defined, all technical and scientific terms used herein have the same meaning as commonly understood by one of ordinary skill in the art to which this disclosure belongs. In case of conflict, the present specification, including definitions, will control.

Except where expressly noted, trademarks are shown in upper case.

Unless stated otherwise, all percentages, parts, ratios, etc., are by weight.

Unless stated otherwise, pressures expressed in psi units are gauge, and pressures expressed in kPa units are absolute. Pressure differences, however, are expressed as absolute (for example, pressure 1 is 25 psi higher than pressure 2).

When an amount, concentration, or other value or parameter is given as a range, or a list of upper and lower values, this is to be understood as specifically disclosing all ranges formed from any pair of any upper and lower range limits, regardless of whether ranges are separately disclosed. Where a range of numerical values is recited herein, unless otherwise stated, the range is intended to include the endpoints thereof, and all integers and fractions within the range. It is not intended that the scope of the present disclosure be limited to the specific values recited when defining a range. As an example, a stated range of 1-10 fully describes and includes the independent subrange 3.4-7.2, as does the following list of values: 1, 3, 5, 8.

When the term “about” is used, it is used to mean a certain effect or result can be obtained within a certain tolerance, and the skilled person knows how to obtain the tolerance. When the term “about” is used in describing a value or an end-point of a range, the disclosure should be understood to include the specific value or end-point referred to.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but can include other elements not expressly listed or inherent to such process, method, article, or apparatus.

The transitional phrase “consisting of” excludes any element, step, or ingredient not specified in the claim, closing the claim to the inclusion of materials other than those recited except for impurities ordinarily associated therewith. When the phrase “consists of” appears in a clause of the body of a claim, rather than immediately following the preamble, it limits only the element set forth in that clause; other elements are not excluded from the claim as a whole.

The transitional phrase “consisting essentially of” limits the scope of a claim to the specified materials or steps and those that do not materially affect the basic and novel characteristic(s) of the claimed invention. A “consisting essentially of” claim occupies a middle ground between closed claims that are written in a “consisting of” format and fully open claims that are drafted in a “comprising” format. Optional additives as defined herein, at a level that is appropriate for such additives, and minor impurities, are not excluded from an embodiment by the term “consisting essentially of” unless they materially affect the basic and novel characteristic(s) of the embodiment in question.

Further, unless expressly stated to the contrary, “or” and “and/or” refers to an inclusive and not to an exclusive. For example, a condition A or B, or A and/or B, is satisfied by any one of the following: A is true (or present) and B is false (or not present), A is false (or not present) and B is true (or present), and both A and B are true (or present).

The use of “a” or “an” to describe the various elements and components herein is merely for convenience and to give a general sense of the disclosure. This description should be read to include one or at least one and the singular also includes the plural unless it is obvious that it is meant otherwise.

The term “predominant portion” or “predominantly”, as used herein, unless otherwise defined herein, means greater than 50% of the referenced material. If not specified, the percent is on a molar basis when reference is made to a molecule (such as hydrogen and ethylene), and otherwise is on a weight basis (such as for additive content).

The term “substantial portion” or “substantially”, as used herein, unless otherwise defined, means all or almost all or the vast majority, as would be understood by the person of ordinary skill in the context used. It is intended to take into account some reasonable variance from 100% that would ordinarily occur in industrial-scale or commercial-scale situations.

The term “depleted” or “reduced” is synonymous with reduced from originally present. For example, removing a substantial portion of a material from a stream would produce a material-depleted stream that is substantially depleted of that material. Conversely, the term “enriched” or “increased” is synonymous with greater than originally present.

The term “virgin” as used herein refers to a generally material that has not been processed to final form (e.g., sheet or film). The form of such materials may vary depending upon their method of making. Simply changing only the physical form of such materials by, e.g., physical or thermal means (e.g. grinding, chopping, pelletizing, etc.) without extruding into the final intended shape (e.g., sheet or film) does not change their “virgin” characteristic.

As used herein, the term “granule” means a particle ranging from a highly irregular shape to spherical. The particle ‘size’ can be defined as a weight per 100 particles. In one embodiment particle ‘size’ is from about 0.01 to 10 grams. In another embodiment, suitably sized recycle material granules (particles), while generally not limited, can range in size from about 0.1 mm, or from about 0.2 mm, to about 5 mm, or to about 4 mm, or to about 2 mm, or to about 1 mm. A granule may be porous and may also be comprised of a collection of smaller particles that are ‘clumped’ or somewhat ‘fused’ together so physically it behaves as a larger particle/granule.

As used herein, the term “pellet” means a polymer resin, generally of a cylindrical shape (strand cut) or close to spherical shape (e.g. underwater melt-cut) with a weight of 0.1 to 10 grams per 100 pellets.

As used herein, the term “fresh” refers to a generally pure material that has been newly made or as received from a vendor and that has not been through any post processing in an attempt to create other forms/shapes or thermal treatments causing melting of the resin.

As used herein, the term “intimately mix,” “intimately mixing,” “intimately mixed,” and “intimate mixing” means combining or the combination of two or more polymeric materials—for example virgin ionomer and recycle material—so that optimum optical distortion parameters are achieved. Thermal treatment (melt mixing, etc.) typically is involved. The measurement of the optical distortion can be by any practical method, including but not limited to the “shadowgraph” technique. Shadowgraph is a sensitive visualization method which can reveal optical non-uniformities within transparent materials, generally by shadows cast by disturbances when light rays are refracted. Another common practice is judging the degree of optical distortion present when viewing a ‘checkerboard’ target grid with and without the sample glass laminate being placed in the direct line-of-sight.

As used herein, the term “shaping” as it refers to polymeric materials means forming the materials into films and sheets. Generally, films are about 0.01 to about 0.25 mm thick, and sheets are about 0.25 mm to about 10 mm thick.

As used herein, the term “longitudinal direction” means in the principle direction of material flow from the film or sheet manufacturing process. This is also sometimes referred to as ‘machine direction’ in the case of an extrusion process creating melt that is formed into film or sheet.

As used herein, the terms “plastic” and “polymer” are used interchangeably. While it is recognized that the term “plastic” can refer to a specific type of polymer and is generally composed of long chains of polymers, and polymers are composed of smaller, uniform molecules, for the present invention, both terms can be used interchangeably.

Measurements of haze, YID and other properties are made in glass laminate form. The combination of haze and yellowness index (YID), especially with a quick cooling profile can have little difference in haze but large difference in YID. Substantially all (about 100%) of each resin can have acceptable YID, but combination of the two resins can have increased yellowness. This can be especially important for mixing in recycle material which has a different thermal profile. Differences are noted between “regular” cooling and “quick” cooling, as well as when different resins are combined, as well as the amounts of each resin and the cooling method that is used. The ionomer resins can have blue colorant added (to make the interlayer film/sheeting appear less yellow), but this is an added step and the addition of such would only compensate for the degree of yellowness at a given compositional blend and cooling rate. Additionally, this approach changes the ‘color’ of the resin towards ‘green’ or even ‘grey’, and would in substantially all cases, reduce the overall light transmission of the article which would further create a distinction between resins blends with or without the blue colorant. Additionally, the refractive index (RI) of each resin is important, especially for haze. This is also generally mixing related. The thickness of the glass laminate interlayer must also be considered, as well as any effects resulting from the extrusion method and resin degradation.

As used herein, the terms “recycle material” and “recycle polymeric material” each refers to polymeric material that contains material that has been recovered from a previously processed polymeric material. The previously processed polymeric material can be in any form, and can be or can include waste material from a process used to make it, i.e., seconds, trimmings and the like.

This polymeric material contains not only one or more polymer(s) but also one or more optional additives. Therefore, when this polymeric material is recycled, the optional additives are also considered “recycled”. Recycle polymeric material can also be obtained from down-stream manufacturing operations, such as trims being derived from the conversion process of film and sheeting being fabricated into glass laminates. Additionally, it is possible that polymeric materials collected can be reprocessed to filter out contaminates through a secondary extrusion process to create material suitable for use. As used herein, the term “copolymer” refers to polymers comprising copolymerized units resulting from copolymerization of two or more comonomers. In this connection, a copolymer may be described herein with reference to its constituent comonomers or to the amounts of its constituent comonomers, for example “a copolymer comprising ethylene and 15 weight % of acrylic acid”, or a similar description. Such a description may be considered informal in that it does not refer to the comonomers as copolymerized units; in that it does not include a conventional nomenclature for the copolymer, for example International Union of Pure and Applied Chemistry (IUPAC) nomenclature; in that it does not use product-by-process terminology; or for another reason. As used herein, however, a description of a copolymer with reference to its constituent comonomers or to the amounts of its constituent comonomers means that the copolymer contains copolymerized units (in the specified amounts when specified) of the specified comonomers. It follows as a corollary that a copolymer is not the product of a reaction mixture containing given comonomers in given amounts, unless expressly stated in limited circumstances to be such.

The term “dipolymer” refers to polymers consisting essentially of two monomers, and the term “terpolymer” refers to polymers comprising at least three monomers.

The term “acid copolymer” as used herein refers to a copolymer comprising copolymerized units of an α-olefin, an α,β-ethylenically unsaturated carboxylic acid, and optionally other suitable comonomer(s) such as, for example, an α,β-ethylenically unsaturated carboxylic acid ester.

The term “(meth)acrylic”, as used herein, alone or in combined form, such as “(meth)acrylate”, refers to acrylic or methacrylic, for example, “acrylic acid or methacrylic acid”, or “alkyl acrylate or alkyl methacrylate”.

The term “ionomer” as used herein generally refers to a polymer that comprises ionic groups that are carboxylate salts, for example, ammonium carboxylates, alkali metal carboxylates, alkaline earth carboxylates, transition metal carboxylates and/or combinations of such carboxylates. Such polymers are generally produced by partially or fully neutralizing the carboxylic acid groups of precursor or parent polymers that are acid copolymers, as defined herein, for example by reaction with a base. The alkali metal ionomer as used herein is a sodium ionomer, for example a copolymer of ethylene and methacrylic acid, wherein all or a portion of the carboxylic acid groups of the copolymerized methacrylic acid units are neutralized, and substantially all of the neutralized carboxylic acid groups are in the form of sodium carboxylates.

For convenience, many elements of the present invention are discussed separately, lists of options may be provided and numerical values may be in ranges; however, for the purposes of the present disclosure, that should not be considered as a limitation on the scope of the disclosure or support of the present disclosure for any claim of any combination of any such separate components, list items or ranges. Unless stated otherwise, each and every combination possible with the present disclosure should be considered as explicitly disclosed for all purposes.

Although methods and materials similar or equivalent to those described herein can be used in the practice or testing of the present disclosure, suitable methods and materials are described herein. The materials, methods, and examples herein are thus illustrative only and, except as specifically stated, are not intended to be limiting.

### Ionomer

In accordance with the present invention, the ionomer resin composition comprises at least two sodium-neutralized ethylene·α,β-unsaturated carboxylic acid copolymers (i.e., ionomers), one of which is a dipolymer having constituent units derived from ethylene and constituent units derived from an α,β-unsaturated carboxylic acid, in which at least a part of the constituent units derived from the α,β-unsaturated carboxylic acid are neutralized with a sodium ion, and the other of which is a terpolymer having constituent units derived from ethylene, constituent units derived from an α,β-unsaturated carboxylic acid, constituent units derived from an α,β-ethylenically unsaturated carboxylic acid ester, and optionally constituent units derived from a derivative of an α,β-unsaturated carboxylic acid other than an ester thereof, such as an amide or anhydride thereof, in which at least a part of the constituent units derived from the α,β-unsaturated carboxylic acid are neutralized with a sodium ion.

In both the dipolymer and the terpolymer, a content proportion of the constituent units derived from an α,β-unsaturated carboxylic acid is typically 2% by mass or more, or 5% by mass or more (based on total copolymer mass), including 7, 10, 12, 14, 15 and 18% by mass or more. In addition, the content proportion of the constituent units derived from an α,β-unsaturated carboxylic acid is typically 30%, 27%, 25%, 23%, or 22% by mass or less (based on total copolymer mass).

Examples of the α,β-unsaturated carboxylic acid constituting the dipolymer and terpolymer ionomers include, without limitation, acrylic acid, methacrylic acid, itaconic acid, maleic acid, fumaric acid, and mixtures of two or more thereof. In one embodiment, the α,β-ethylenically unsaturated carboxylic acid is selected from acrylic acid, methacrylic acid, and mixtures thereof. In another embodiment, the α,β-ethylenically unsaturated carboxylic acid is methacrylic acid.

The terpolymer further comprises copolymerized units of one or more α,β-ethylenically unsaturated carboxylic acid esters. Alkyl esters having 3 to 10, or 3 to 8 carbons, are typically used. Specific examples of suitable esters of unsaturated carboxylic acids include, without limitation, methyl acrylate, methyl methacrylate, ethyl acrylate, ethyl methacrylate, propyl acrylate, propyl methacrylate, isopropyl acrylate, isopropyl methacrylate, n-butyl acrylate, n-butyl methacrylate, isobutyl acrylate, isobutyl methacrylate, tert-butyl acrylate, tert-butyl methacrylate, octyl acrylate, octyl methacrylate, undecyl acrylate, undecyl methacrylate, octadecyl acrylate, octadecyl methacrylate, dodecyl acrylate, dodecyl methacrylate, 2-ethylhexyl acrylate, 2-ethylhexyl methacrylate, isobornyl acrylate, isobornyl methacrylate, lauryl acrylate, lauryl methacrylate, 2-hydroxyethyl acrylate, 2-hydroxyethyl methacrylate, glycidyl acrylate, glycidyl methacrylate, dimethyl maleate, diethyl maleate, dibutyl maleate, dimethyl fumarate, diethyl fumarate, dibutyl fumarate, dimethyl fumarate, vinyl acetate, vinyl propionate, and mixtures of two or more thereof. In one embodiment, the additional comonomers are selected from methyl acrylate, methyl methacrylate, n-butyl acrylate, n-butyl methacrylate, isobutyl acrylate, isobutyl methacrylate, glycidyl methacrylate, vinyl acetate, and mixtures of two or more thereof. In another embodiment, one or more of n-butyl acrylate, n-butyl methacrylate, isobutyl acrylate and isobutyl methacrylate are used. In another embodiment, one or both of n-butyl acrylate and isobutyl acrylate are used.

In one embodiment one or both of the dipolymer and terpolymer have a melt flow rate (MFR) of from about 1, or from about 2, to about 4000 g/10 min, or to 1000 g/10 min, or to about 400 g/10 min, as determined in accordance with ASTM method D1238-89 at 190° C. and 2.16 kg.

One of ordinary skill is capable of synthesizing the described dipolymers and terpolymers based on their descriptions herein, optionally in view of the descriptions in, for example, U.S. Pat. Nos. 3,404,134, 5,028,674, 6,500,888B2, U.S. Pat. No. 6,518,365B1, U.S. Pat. No. 8,334,033B2 and U.S. Pat. No. 8,399,096B2. In one embodiment, a method described in U.S. Pat. No. 8,399,096B2 is used, and a sufficiently high level and complementary amount of the derivative of the second α,β-ethylenically unsaturated carboxylic acid is present in the reaction mixture.

In one embodiment, to obtain the dipolymer and terpolymer ionomers their ethylene acid copolymer precursors are partially neutralized by reaction with one or more sodium bases. An example of a suitable procedure for neutralizing the ethylene acid copolymers is described in U.S. Pat. Nos. 3,404,134 and 6,518,365B1. After neutralization, about 1%, or about 10%, or about 15%, or about 20%, to about 90%, or to about 60%, or to about 55%, or to about 30%, of the hydrogen atoms of carboxylic acid groups present in the ethylene acid copolymer precursor are replaced by other cations. Stated alternatively, about 1%, or about 10%, or about 15%, or about 20%, to about 90%, or to about 60%, or to about 55%, or to about 30%, of the total content of the carboxylic acid groups present in the ethylene acid copolymer precursor are neutralized. In another alternative expression, the acid groups are neutralized to a level of about 1%, or about 10%, or about 15%, or about 20%, to about 90%, or to about 60%, or to about 55%, or to about 30%, based on the total content of carboxylic acid groups present in the ethylene acid copolymer precursors as calculated or measured for the non-neutralized ethylene acid copolymer precursors. The neutralization level can be tailored for the specific end-use.

The counterions to the carboxylate anions in the ionomer are sodium cations. In one embodiment the ionomers used in the present invention are sodium-neutralized ionomers wherein the counterions are substantially sodium ions, with counterions other than sodium cations optionally present in small amounts of less than 5 equivalent %, or less than 3 equivalent %, or less than 2 equivalent %, or less than 1 equivalent %, based on the total equivalents of carboxylate groups in the ionomer.

Suitable cations other than alkali metal cations include any positively charged species that is stable under the conditions in which the ionomer composition is synthesized, processed and used. Suitable cations may be used in combinations of two or more. Typically, such other cations are metal cations, which may be monovalent, divalent, trivalent, or multivalent. Monovalent metal cations include but are not limited to cations of potassium, lithium, silver, mercury, copper, and the like. Divalent metal cations include but are not limited to cations of beryllium, magnesium, calcium, strontium, barium, copper, cadmium, mercury, tin, lead, iron, cobalt, nickel, zinc, and the like. Trivalent metal cations include but are not limited to cations of aluminum, scandium, iron, yttrium, and the like. Multivalent metal cations include but are not limited to cations of titanium, zirconium, hafnium, vanadium, tantalum, tungsten, chromium, cerium, iron, and the like. When the metal cation is multivalent, complexing agents such as stearate, oleate, salicylate, and phenolate radicals may be included, as described in U.S. Pat. No. 3,404,134. Typically, when present, the metal cations used are monovalent or divalent metal cations, such as lithium, magnesium, zinc, potassium, and combinations of one or more of these metal cations.

In one embodiment, counterions other than sodium are present in at most “contaminant” amounts, as one would typically find in industrial situations, as would be recognized by persons of ordinary skill in the relevant art. Because sodium is a preferred counterion herein, reference will primarily be made to sodium hereinafter, but all counterions contemplated can be used in any embodiment described herein.

The resulting sodium-neutralized ethylene acid dipolymer and terpolymer is an ionomer and has a melt index, as determined in accordance with ASTM method D1238-89 at 190° C. and 2.16 kg, that is lower than that of its corresponding ethylene acid copolymer precursor. The ionomer's melt index depends on a number of factors, including the melt index of the ethylene acid copolymer, the amount of copolymerized acid, the neutralization level, the identity of the cation and its valency. Moreover, the desired value of the ionomer's melt index may be determined by its intended end use. Typically, however, the ionomer has a melt index of about 1000 g/10 min or less, or about 750 g/10 min or less, or about 500 g/10 min or less, or about 250 g/10 min or less, or about 100 g/10 min or less, or about 50 g/10 min or less, or about 25 g/10 min or less, or about of 20 g/10 min or less, or about 10 g/10 min or less, or about 7.5 g/10 min or less, as determined in accordance with ASTM method D1238-89 at 190° C. and 2.16 kg.

In one embodiment, the dipolymer consists essentially of, or consists of, copolymerized units of (i) ethylene, and (ii) from about 10 wt %, or from about 15 wt %, or from about 18 wt %, or from about 20 wt %, to about 30 wt %, or to about 25 wt %, or to about 23 wt % or to about 22 wt %, of at least one α,β-unsaturated carboxylic acid having 3 to 10 carbon atoms, wherein the weight percentages of the copolymerized units are based on the total weight of the dipolymer and the sum of the weight percentages of the copolymerized units is 100 wt %, and wherein at least a portion of carboxylic acid groups of the α,β-unsaturated carboxylic acid are neutralized to form an ionomer comprising carboxylate groups having sodium counterions.

In one embodiment, the terpolymer comprises, consists essentially of, or consists of copolymerized units of: (i) ethylene, (ii) from about 10 wt %, or from about 15 wt %, or from about 18 wt %, or from about 20 wt %, to about 30 wt %, or to about 25 wt %, or to about 23 wt % or to about 22 wt %, of at least one α,β-unsaturated carboxylic acid having 3 to 10 carbon atoms, (iii) from about 2 wt %, or from about 3 wt %, or from about 4 wt %, or from about 5 wt %, to about 15 wt %, or to about 12 wt %, or to about 11 wt %, or to about 10 wt %, of at least one α,β-unsaturated carboxylic acid ester having 3 to 10 carbon atoms, and (iv) optionally a derivative of an α,β-unsaturated carboxylic acid other than (iii) in an amount such that (iii)+ (iv) is about 15 wt % or less, or about 12 wt % or less, or about 11 wt % or less, wherein the weight percentages of the copolymerized units are based on the total weight of the terpolymer and the sum of the weight percentages of the copolymerized units is 100 wt %, and wherein at least a portion of carboxylic acid groups of the α,β-unsaturated carboxylic acid are neutralized to form an ionomer comprising carboxylate groups having sodium counterions.

Such terpolymer ionomers are generally disclosed in WO2015/199750A1, WO2014/100313A1 and US2017/0320297A1.

In one embodiment of the dipolymer and/or terpolymer the α,β-unsaturated carboxylic acid is methacrylic acid.

In one embodiment of the terpolymer, the α,β-unsaturated carboxylic acid ester is n-butyl acrylate, isobutyl acrylate or a mixture thereof.

In one embodiment of the terpolymer it consists of, or consists essentially of, copolymerized units of (i), (ii) and (iii).

In one embodiment, the weight ratio of alkali metal-neutralized ethylene acid dipolymer ionomer resin to alkali metal-neutralized ethylene acid ester terpolymer ionomer resin (w/w dipolymer/terpolymer) in the composition, based on total weight of dipolymer and terpolymer, is not particularly limited. In one embodiment, the weight ratio of alkali metal-neutralized ethylene acid dipolymer ionomer resin to alkali metal-neutralized ethylene acid ester terpolymer ionomer resin (w/w dipolymer/terpolymer) in the composition, based on total weight of dipolymer and terpolymer, is 1/99 to 99/1, inclusive of 3/97-97/3, 5/95-95/5, 10/90-90/10, 15/85-85/15, 20/80-80/20, 25/75-75/25, 30/70-70/30, 35/65-65/35, 40/60-60/40, 45/55-55/45, and

In one embodiment, one of (i) or (ii) is from about 5 wt % to about 30 wt %, or to about 25 wt %, to about 20 wt %, to about 15 wt %, or to about 10 wt %, based on the combined weight of (i)+ (ii). In another embodiment, one of (i) or (ii) is from about 10 wt % to about 30 wt %, or to about 25 wt %, to about 20 wt %, or to about 15 wt %, based on the combined weight of (i)+ (ii). In another embodiment, one of (i) or (ii) is from about 15 wt % to about 30 wt %, or to about 25 wt %, to about 20 wt %, based on the combined weight of (i)+ (ii). In another embodiment, one of (i) or (ii) is from about 20 wt % to about 30 wt %, or to about 25 wt %, based on the combined weight of (i)+ (ii). In another embodiment, one of (i) or (ii) is from about 25 wt % to about 30 wt %, based on the combined weight of (i)+ (ii).

In one embodiment the total amount of dipolymer and terpolymer present in the composition is, based on the total weight of polymer (exclusive of additives) of any type present in the composition, all or, substantially all of the composition.

### Adhesion Promoter

Optional adhesion promotors suitable for use in accordance with the present invention compositions are dialkoxysilanes. Without being held to theory, it is believed that the hydrolyzed silanol portion of the silane can form an adhesive bond with a glass surface (silanols), thereby enhancing the adhesive force at the interface between the polymer and glass surface. The remaining portion of the silane molecule should then ‘anchor’ in some fashion and to some degree, with the surrounding ionomer resin ‘matrix’. One way to achieve this is to choose functional groups which would interact in a favorable manner to allow the silane to either bond, chemically or through ionic or hydrogen bonding or sufficient van der Waals forces, or be of a size and shape that sterically, can “bridge” between the interlayer and glass surface, thereby increasing the adhesion over the same interlayer without the advantageous silane additive.

In one embodiment, each of the alkoxy groups individually contains from 1 to 3 carbon atoms. Suitable examples include diethoxydimethylsilane, diethoxyl(methyl) vinylsilane, 1,3-diethoxy-1,1,3,3-tertramethyldisiloxane, dimethoxydimethylsilane, dimethoxylmethylvinylsilane, methyldiethoxysilane, diisopropyldimethoxysilane, dicyclopentyldimethoxysilane, γ-aminopropyl-N-cyclohexylmethyldimethoxysilane, 3-aminopropylmethyldimethoxysilane, N-phenyl-3-aminopropylmethyldimethoxysilane, N-phenyl-3-aminopropylmethyldiethoxysilane, N-β-(aminoethyl)-γ-aminopropylmethyldimethoxysilane and 3-glycidoxypropylmethyldiethoxysilane.

In another embodiment, in addition to the alkoxy groups the silane also contains an “active” chemical group for bonding into the ionomer resin matrix, for example, a carboxylic acid-reactive group such as an amino group or a glycidyl group. Suitable examples include γ-aminopropyl-N-cyclohexylmethyldimethoxysilane, 3-aminopropylmethyldimethoxysilane, N-phenyl-3-aminopropylmethyldimethoxysilane, N-phenyl-3-aminopropylmethyldiethoxysilane, N-β-(aminoethyl)-γ-aminopropylmethyldimethoxysilane and 3-glycidoxypropylmethyldiethoxysilane.

Desirably the silane is a liquid under ambient conditions (for example, at 20° C.). Specific such examples include N-β-(aminoethyl)-γ-aminopropylmethyldimethoxysilane (CAS #3069-29-2) and 3-glycidoxypropylmethyldiethoxysilane (CAS #2897-60-1).

Although a critical minimum level of adhesion is necessary to maintain sufficient laminate integrity (e.g. preventing delamination defects) and sufficient retention of glass in a post-fractured state, optimization or adjustment of the impact performance of the resulting laminate can be made by intent. Though an optimal addition amount of the adhesion modifier (cumulative) varies with the additive to be used and the resin to be adhesion modified, it is preferably adjusted in such a manner that an adhesive force of the resulting laminate to a glass is generally adjusted to about 3 or more and about 10 or less in a pummel test (described in WO03/033583A1 or the like). In particular, in the case where high penetration resistance is required, the addition amount of the adhesion modifier is more preferably adjusted in such a manner that the adhesive force is about 3 or more and about 6 or less, whereas in the case where high glass shattering preventing properties are required, the addition amount of the adhesion modifier is more preferably adjusted in such a manner that the adhesive force is about 7 or more and about 10 or less.

### Other Additives

Other than the aforementioned optional dialkoxysilanes, and regardless of their presence or absence, the resin compositions and masterbatches of the present invention may optionally contain one or more other additives including, for example, an antioxidant, an ultraviolet ray absorber, a photostabilizer, an antiblocking agent, a pigment, a dye, a heat shielding material (infrared ray absorber) and the like, or mixtures thereof. Such other additives are in a general sense well known to those of ordinary skill in the relevant art.

Examples of the antioxidant include phenol-based antioxidants, phosphorus-based antioxidants, sulfur-based antioxidants, and the like. Of those, phenol-based antioxidants are preferred, and alkyl-substituted phenol-based antioxidants are especially preferred.

Examples of the phenol-based antioxidant include acrylate-based compounds, such as 2-t-butyl-6-(3-t-butyl-2-hydroxy-5-methylbenzyl)-4-methylphenyl acrylate and 2,4-di-t-amyl-6-(1-(3,5-di-t-amyl-2-hydroxyphenyl)ethyl)phenyl acrylate; alkyl-substituted phenol-based compounds, such as 2,6-di-t-butyl-4-methylphenol, 2,6-di-t-butyl-4-ethylphenol, octadecyl-3-(3,5-di-t-butyl-4-hydroxyphenyl) propionate, 2,2′-methylene-bis(4-methyl-6-t-butylphenol), 4,4′-butylidene-bis(4-methyl-6-t-butylphenol), 4,4′-butylidene-bis(6-t-butyl-m-cresol), 4,4′-thiobis(3-methyl-6-t-butylphenol), bis(3-cyclohexyl-2-hydroxy-5-methylphenyl) methane, 3,9-bis(2-(3-(3-t-butyl-4-hydroxy-5-methylphenyl) propionyloxy)-1,1-dimethylethyl)-2,4,8,10-tetraoxaspiro[5.5]undecane, 1,1,3-trix(2-methyl-4-hydroxy-5-t-butylphenyl) butane, 1,3,5-trimethyl-2,4,6-tris(3,5-di-t-butyl-4-hydroxybenzyl)benzene, tetrakis(methylene-3-(3′,5′-di-t-butyl-4′-hydroxyphenyl) propionate) methane and triethylene glycol bis(3-(3-t-butyl-4-hydroxy-5-methylphenyl) propionate); triazine group-containing phenol-based compounds, such as 1,3,5-tris(2,6-dimethyl-3-hydroxy-4-t-butylbenzyl)-1,3,5-triazine-2,4,6 (1H,3H,5H)-trione, 6-(4-hydroxy-3,5-di-t-butylanilino)-2,4-bis-octylthio-1,3,5-triazine, 6-(4-hydroxy-3,5-dimethylanilino)-2,4-bis-octylthio-1,3,5-triazine, 6-(4-hydroxy-3-methyl-5-t-butylanilino)-2,4-bis-octylthio-1,3,5-triazine and 2-octylthio-4,6-bis-(3,5-di-t-butyl-4-oxyanilino)-1,3,5-triazine; and the like.

Examples of the phosphorus-based antioxidant include monophosphite-based compounds, such as triphenyl phosphite, diphenylisodecyl phosphite, phenyldiisodecyl phosphite, tris(nonylphenyl) phosphite, tris(dinonylphenyl) phosphite, tris(2-t-butyl-4-methylphenyl) phosphite, tris(2,4-di-t-butyl) phosphite, tris(cyclohexylphenyl) phosphite, 2,2-methylenebis(4,6-di-t-butylphenyl) octyl phosphite, 9,10-dihydro-9-oxa-10-phosphaphenanthrene-10-oxide, 10-(3,5-di-t-butyl-4-hydroxybenzyl)-9,10-dihydro-9-oxa-10-phosphaphenanthrene-10-oxide and 10-decyloxy-9,10-dihydro-9-oxa-10-phosphaphenanthrene; diphosphite-based compounds, such as 4,4′-butylidene-bis(3-methyl-6-t-butylphenyl-di-tridecylphosphite), 4,4′-isopropylidene-bis (phenyl-di-alkyl(C12-C15) phosphite), 4,4′-isopropylidene-bis(diphenylmonoalkyl(C12-C15) phosphite), 1,1,3-tris(2-methyl-4-di-tridecylphosphite-5-t-butylphenyl) butane and tetrakis(2,4-di-t-butylphenyl)-4,4′-biphenylene phosphite; and the like. Of those, monophosphite-based compounds are preferred.

Examples of the sulfur-based antioxidant include dilauryl 3,3′-thiodipropionate, distearyl 3,3-thiodipropionate, lauryl stearyl 3,3′-thiodipropionate, pentaerythritol-tetrakis-(β-lauryl-thiopropionate), 3,9-bis(2-dodecylthioethyl)-2,4,8,10-tetraoxaspiro[5.5]undecane, and the like.

These antioxidants can be used solely or in combination of two or more thereof. In the final resin composition, the antioxidant utilized is typically about 0.001 parts by weight or more, or about 0.01 parts by weight or more, based on 100 parts by weight of the ionomer resin. In addition, the amount of antioxidant utilized is typically about 5 parts by weight or less, or about 1 part by weight or less, based on 100 parts by weight of the ionomer resin (dipolymer and terpolymer).

Examples of the ultraviolet ray absorber include benzotriazole-based ultraviolet ray absorbers, such as 2-(5-methyl-2-hydroxyphenyl) benzotriazole, 2-[2-hydroxy-3,5-bis(α,α′-dimethylbenzyl)phenyl]-2H-benzotriazole, 2-(3,5-di-t-butyl-2-hydroxyphenyl) benzotriazole, 2-(3-t-butyl-5-methyl-2-hydroxyphenyl)-5-chlorobenzotriazole, 2-(3,5-di-t-butyl-5-methyl-2-hydroxyphenyl)-5-chlorobenzotriazole and 2-(3,5-di-t-amyl-2-hydroxyphenyl) benzotriazole, 2-(2′-hydroxy-5′-t-octylphenyl) triazole; hindered amine-based ultraviolet ray absorbers, such as 2,2,6,6-tetramethyl-4-piperidyl benzoate, bis(2,2,6,6-tetramethyl-4-piperidyl) sebacate, bis(1,2,2,6,6-pentamethyl-4-piperidyl)-2-(3,5-di-t-butyl-4-hydroxybenzyl)-2-n-butylmalonate and 4-(3-(3,5-di-t-butyl-4-hydroxyphenyl) propionyloxy)-1-(2-(3-(3,5-di-t-butyl-4-hydroxyphenyl) propionyloxy)ethyl)-2,2,6,6-tetramethylpiperidine; benzoate-based ultraviolet ray absorbers, such as 2,4-di-t-butylphenyl-3,5-di-t-butyl-4-hydroxybenzoate and hexadecyl-3,5-di-t-butyl-4-hydroxybenzoate; and the like.

These ultraviolet ray absorbers can be used solely or in combination of two or more thereof. In the final resin composition, the amount of ultraviolet ray absorber utilized is typically about 10 ppm by weight or more, or about 100 ppm by weight or more, based on the weight of the ionomer resin. In addition, the amount of ultraviolet ray absorber utilized is typically about 50,000 ppm or less, or about 10,000 ppm or less, based on the weight of the ionomer resin.

In some embodiments, it is also possible to use two or more types of UV absorbers in combination.

In other embodiments, no UV absorber is added, or the compositions and masterbatches are substantially UV absorber additive free.

Examples of the photostabilizer include hindered amine-based materials, such as “ADEKA STAB LA-57” (a trade name) manufactured by Adeka Corporation, and “TINUVIN 622” (a trade name) manufactured by Ciba Specialty Chemicals Inc.

When a laminated glass is prepared by incorporating a heat-shielding fine particle or a heat-shielding compound as the heat-shielding material into the interlayer of the present invention to give a heat-shielding function to the laminate, a transmittance at a wavelength of 1,500 nm can be regulated to about 50% or less, or the TDS value (calculated from ISO 13837:2008) can be regulated to less than about 43%.

Examples of the heat-shielding fine particle include a metal-doped indium oxide, such as tin-doped indium oxide (ITO), a metal-doped tin oxide, such as antimony-doped tin oxide (ATO), a metal-doped zinc oxide, such as aluminum-doped zinc oxide (AZO), a metal element composite tungsten oxide represented by a general formula: MₘWOₙ (M represents a metal element; m is about 0.01 or more and about 1.0 or less; and n is about 2.2 or more and about 3.0 or less), zinc antimonate (ZnSb₂O₅), lanthanum hexaboride, and the like. Of those, ITO, ATO, and a metal element composite tungsten oxide are preferred, and a metal element composite tungsten oxide is more preferred. Examples of the metal element represented by M in the metal element composite tungsten oxide include Cs, Tl, Rb, Na, K, and the like, and in particular, Cs is preferred. From the viewpoint of heat shielding properties, m is preferably about 0.2 or more, or about 0.3 or more, and it is preferably about 0.5 or less, or about 0.4 or less.

From the viewpoint of transparency of the ultimate laminate, an average particle diameter of the heat shielding fine particle is preferably about 100 nm or less, or about 50 nm or less. It is to be noted that the average particle diameter of the heat shielding particle as referred to herein means one measured by a laser diffraction instrument.

In the final resin composition, a content of the heat shielding fine particle is preferably about 0.01% by weight or more, or about 0.05% by weight or more, or about 0.1% by weight or more, or about 0.2% by weight or more relative to the weight of the ionomer resin. In addition, the content of the heat shielding fine particle is preferably about 5% by weight or less, or about 3% by weight or less.

Examples of the heat shielding compound include phthalocyanine compounds, naphthalocyanine compounds, and the like. From the viewpoint of further improving the heat shielding properties, it is preferred that the heat shielding compound contains a metal. Examples of the metal include Na, K, Li, Cu, Zn, Fe, Co, Ni, Ru, Rh, Pd, Pt, Mn, Sn, V, Ca, Al, and the like, with Ni being especially preferred.

A content of the heat shielding compound is preferably about 0.001% by weight or more, or about 0.005% by weight or more, or about 0.01% by weight or more, based on the weight of the ionomer resin. In addition, the content of the heat shielding compound is preferably about 1% by weight or less, or about 0.5% by weight or less.

### Production of Resin Compositions

The resin compositions of the present invention can be produced as melt blends by feeding the various components into an extruder and intimately mixing the components under melt conditions for the ionomer resins to produce a substantially uniform mixture that can ultimately be formed into the final shape, for example, by melt extrusion or molding.

As would be recognized by those of ordinary skill in the relevant art, in melt blending, attention must be given to ensure mixing is intense enough to blend the components to a sufficient degree of uniformity. Generally this high degree of mixing via extrusion compounding is performed by creating enough shear and residence time in the extruder. Care must also be taken to avoid undesirable results such as localized high concentrations of components, or decomposition of the components due to high temperatures, etc., Formation of discolored resin, gel or degraded product (e.g. black specks) can be avoided by choice of the correct process equipment and process conditions, and is within the skill of those of ordinary skill in the relevant art.

For example, it is well understood that the extent of hydrolysis of the dialkoxysilane will be heightened with undue exposure to moisture and at extended time, perhaps requiring further consideration for controlling extraneous moisture contact. Blanketing with dry-air or nitrogen might be necessary, for example, to maintain a desired minimal degree of hydrolysis of the silane.

The size of the ionomer resin particles, both for the dipolymer and the terpolymer, is not particularly limited. Suitably sized particles for preparing the final compositions can preferably range in size from about 0.1 mm, or from about 0.2 mm, to about 5 mm, or to about 4 mm, or to about 2 mm, or to about 1 mm. Such particles can be measured by an optical microscope with a stage micrometer. Particles up to 1 mm can be measured using a stage micrometer of 1 mm with divisions of 0.01 mm. Particles greater than 1 mm can be measured using a stage micrometer of 25 mm with divisions of 0.05 mm. For the diameter, or in the case of oblong or irregularly-shaped particles, the largest dimension of 20 particles randomly selected from the resin can be measured and the average of 20 particles used to characterize the general particle size.

In one embodiment, the particles for preparing the invention compositions are reduced from nominal pellet size, for example, by cryogenic grinding. For example, cryogenic grinding can be used to reduce the ionomer resin pellets from a nominal average particle size of about 4 mm diameter down to about average particle size ranging from about 0.1 mm to about 0.5 mm particle size. Reducing the particle size in this manner increases the particle surface area relative to the particle weight. Also, these particles are fractured during the milling process and are of irregular shape and this can further increase the surface area relative to particle weight as compared with nominally spherical ionomer resin pellet shapes. Cryogenic grinding processes are generally well known to those of ordinary skill in the relevant art, and typically involve the use of liquid nitrogen to chill pellets in advance of the grinding/milling process. Once cooled, the pellets proceed through a mechanical mill. The use of liquid nitrogen to chill the pellets enables more effective size reduction without undo heating and polymer degradation.

These ionomer resin particles can also be prepared by other conventional means, for example, via underwater melt cutting (for example, “micropellets” having an average diameter of about 0.5 to about 1.5 mm) or other methods well known to those of ordinary skill in the relevant art.

Alternatively, a particulate resin composition can be directly prepared by mixing the particulate dipolymer and terpolymer ionomer resins and optional dialkoxysilane additive as above (imbibe the silane additive on the surface of the resin particles) but in amounts to result in the end concentration of components.

The dialkoxysilane additive, if present, is preferably present in the final resin composition in an amount of from about 50, or from about 100, or from about 250, or from about 500, or from about 750, to about 5000, or to about 4000, or to about 2000, or to about 1500, or to about 1250, parts per million by weight based on the total weight of the dipolymer and terpolymer ionomer resins.

The dialkoxysilane additive may be added to the compositions of the invention (masterbatch and otherwise), in whole or in part, as recycle material such as polymeric material that has been recovered from a previously produced polymeric material and which contains the dialkoxysilane. The recycle material preferably comprises at least one of the dipolymer and terpolymer in addition to the dialkoxysilane additive.

The previously produced material can be waste material from a process used to make it, i.e., seconds, trimmings and the like. This material generally contains not only polymer(s) but also one or more additives. Therefore, when this polymeric material containing additives is recycled, the additives are also considered “recycled”. Recovered polymeric material can also be obtained from down-stream manufacturing operations, such as trims being derived from the conversion process of film and sheeting being fabricated into glass laminates. Additionally, it is possible that polymeric materials collected can be reprocessed to filter out contaminates through a secondary extrusion process to create material suitable for use.

Once recycled material is obtained, it can be fed back into the processes used to make the invention final compositions and masterbatches along with other resins, including virgin resin. Additional additives might also be included during the processing alongside the recycled material. The recycled material generally will contain additives, since this material typically had been previously extruded for the purpose of creating, e.g., interlayer film/sheeting product.

The physical size and dimensions of the recycle material may require some additional processing steps to facilitate it being ‘fed’ back into the process for blending, mixing, extruding, etc. Additionally, reducing the size and optimizing the physical form of the recycle material will improve the uniformity of the re-processed resin and minimize any optical non-uniformities in the finished film/sheet and resulting glass laminate when used for this purpose. This is valid whether the recycle is fed at 100% loading or in blends with virgin resin or other resins and additives. Alternatively, intensive extrusion compounding can be utilized to uniformly blend out inhomogeneities, but this can also contribute to the creation of additional resin degradation, often manifesting itself as increased yellowness and degraded resin (e.g. ‘black specks’).

If the form of the recycle material requires a size-reduction step, various means exist to accomplish this step. Rotary cutting, mechanical chopping, slicing, shearing or other size reducing techniques may be used to prepare the recycle material for refeeding/introduction back into the process. Suitably sized ionomer resin recycle particles range in size from about 0.1 mm, or from about 0.2 mm, to about 5 mm, or to about 4 mm, or to about 2 mm, or to about 1 mm. Such particles can be measured by an optical microscope with a stage micrometer. Particles up to 1 mm can be measured using a stage micrometer of 1 mm with divisions of 0.01 mm. Particles greater than 1 mm can be measured using a stage micrometer of 25 mm with divisions of 0.05 mm. For the diameter, or in the case of oblong or irregularly-shaped particles, the largest dimension of 20 particles randomly selected from the resin can be measured and the average of 20 particles used to characterize the general particle size. For example, cryogenic grinding can be used to reduce the ionomer resin materials from their larger form to a nominal average particle size of about 4 mm down to about an average particle size ranging from about 0.1 mm to about 0.5 mm particle size. Also, these particles are fractured during the milling process and are of irregular shape. Cryogenic grinding processes are generally well known to those of ordinary skill in the relevant art, and typically involve the use of liquid nitrogen to chill resin materials in advance of the grinding/milling process. Once cooled, the recycle resin materials proceed through a mechanical mill. The use of liquid nitrogen to chill the resin materials enables more effective size reduction without undo heating and contribution to further polymer degradation.

In some cases, edge trim, for example, can be fed directly back into the extrusion process with proper equipment design (e.g. guide/pull rolls and screw design). Sometimes feed can be introduced into a ‘side feeder’ so that it is combined with the primary feed. Any means for returning recycle material is within the scope of the invention. As described above, this recycle material may comprise, in addition to one or more dialkoxysilanes, one or more additives, such as those described above.

Additional additives if present can be mixed as part of the masterbatch, or can be added in the preparation of the final resin composition via conventional means as would be recognized by persons of ordinary skill in the relevant art.

### Sheets/Interlayers

Sheets of the ionomer resin compositions of the present invention can be prepared by conventional melt extrusion or melt molding processes suitable for making interlayers for glass laminates. Such processes are well-known to those of ordinary skill in the relevant art, as exemplified by the previously incorporated publications.

The sheets can be monolayer or multilayer sheets. For example, multilayer sheets can be formed having a functional core layer sandwiched between two exterior layers and other optional interior layers. In one embodiment, at least one (or both) of the exterior layers of the multilayer interlayer is a sheet of the ionomer resin composition in accordance with the present invention.

As one example of a functional core layer there can be mentioned an acoustic damping layer, such as a polystyrene copolymer intermediate film (see JP2007-91491A), a polyvinyl acetal layer (see US2013/0183507A1, U.S. Pat. No. 8,741,439B2, JP2012-214305A and U.S. Pat. No. 8,883,317B2), a viscoelastic acrylic layer (see U.S. Pat. No. 7,121,380B2), a layer containing a copolymer of styrene and a rubber-based resin monomer (see JP2009-256128A), a layer containing a polyolefin (see US2012/0204940A1), a layer containing an ethylene/vinyl acetate polymer (see WO2015/013242A1), a layer containing an ethylene acid copolymer (see WO2015/085165A1).

In one specific embodiment, the intermediate layer is thermoplastic elastomer resin, such as disclosed WO2016/076336A1, WO2016/076337A1, WO2016/076338A1 in WO2016/076339A1, WO2016/076340A1 and US2017/0320297A1. In a more specific embodiment, the thermoplastic elastomer resin is a hydrogenated product of a block copolymer having:
(i) an aromatic vinyl polymer block (a) containing about 60 mol % or more of an aromatic vinyl monomer unit, based on the aromatic vinyl polymer block, and
(ii) an aliphatic unsaturated polymer block (b) containing about 60 mol % or more of a conjugated diene monomer unit, based on the aliphatic unsaturated polymer block,

wherein the aliphatic unsaturated polymer block (b) contains about 50 mol % or more in total of an isoprene unit and a butadiene unit as the conjugated diene monomer unit, and

wherein the amount of residual carbon-carbon double bonds the aliphatic unsaturated polymer block derived from conjugated diene monomer units is from about 2 to about 40 mol %.

Further, the interlayer as a whole can be symmetric having a substantially consistent thickness, or can be asymmetric wherein a portion of the interlayer has a thickness greater than another portion (for example, partial or full “wedge”, as discussed in US2017/0320297A1 and US2018/0117883A1. Further, the laminate can be substantially clear or having coloring in all or a portion (for example, “shadeband” as discussed in US2017/0320297A1 and US2018/0117883A1.

In a symmetric construction, the interlayer preferably possesses a total film thickness of about 320 μm or more, or about 420 μm or more. In addition, the total film thickness should be about 1250 μm or less, or about 1,000 μm or less.

In an asymmetric construction such as a wedge, the thinner portion of the interlayer should possess the thicknesses of a symmetric construction, while the thickness of the thick portion will depend on various parameters such as wedge angle. In one embodiment of a wedge-shaped interlayer, the thicker edge has a thickness of about 1850 μm or less, or about 1600 μm or less, or about 1520 μm or less, or about 1330 μm or less, or about 1140 μm or less; and the thinner edge has a thickness of about 600 μm or more, or about 700 μm or more, or about 760 μm or more.

In addition, a concave and convex structure, such as an embossing, can be formed on the surface of the interlayer of the present invention by conventionally known methods for assistance in deairing in laminate production. The shape of the embossing is not particularly limited, and those which are conventionally known can be adopted.

In one embodiment, at least one surface (and preferably both surfaces) of the interlayer for a laminated glass is shaped. By shaping at least one surface of the interlayer for a laminated glass, in the case where a laminated glass is produced, an air bubble present at an interface between the interlayer for a laminated glass and a glass easily escapes to the outside of the laminated glass, and thus, the appearance of the laminated glass can be made favorable. It is preferred to shape at least one surface of the interlayer for a laminated glass by an embossing roll method. By shaping the surface of the interlayer for a laminated glass, a concave portion and/or a convex portion are/is formed on the surface of the interlayer for a laminated glass.

An embossing roll to be used in the embossing roll method can be produced, for example, by using an engraving mill (mother mill) having a desired concave-convex pattern and transferring the concave-convex pattern to the surface of a metal roll. Further, an embossing roll can also be produced using laser etching. Further, after forming a fine concave-convex pattern on the surface of a metal roll as described above, the surface with the fine concave-convex pattern is subjected to a blast treatment using an abrasive material such as aluminum oxide, silicon oxide, or glass beads, whereby a finer concave-convex pattern can also be formed.

Further, the embossing roll to be used in the embossing roll method is preferably subjected to a release treatment. In the case where an embossing roll which is not subjected to a release treatment is used, it becomes difficult to release the interlayer for a laminated glass from the embossing roll. Examples of a method for the release treatment include known methods such as a silicone treatment, a Teflon (registered trademark) treatment, and a plasma treatment.

The depth of the concave portion and/or the height of the convex portion (hereinafter sometimes referred to as “the height of the embossed portion”) of the surface of the interlayer for a laminated glass shaped by an embossing roll method or the like are/is typically about 5 μm or more, or about 10 μm or more, or about 20 μm or more. The height of the embossed portion is typically about 150 μm or less, or about 100 μm or less, or about 80 μm or less.

In the invention, the height of the embossed portion refers to a maximum height roughness (Rz) defined in JIS B 0601 (2001). The height of the embossed portion can be measured by, for example, utilizing the confocal principle of a laser microscope or the like. Incidentally, the height of the embossed portion, that is, the depth of the concave portion or the height of the convex portion may vary within a range that does not depart from the gist of the invention.

Examples of the form of the shape imparted by an embossing roll method or the like include a lattice, an oblique lattice, an oblique ellipse, an ellipse, an oblique groove, and a groove. The inclination angle of such form is typically from about 10° to about 80° with respect to the film flow direction (MD direction). Further, the shaping pattern may be a regular pattern or an irregular pattern such as a random matte pattern, or a pattern such as disclosed in U.S. Pat. No. 7,351,468B2.

The shaping by an embossing roll method or the like may be performed on one surface of the interlayer for a laminated glass, or may be performed on both surfaces, but is more typically performed on both surfaces.

### Laminates

It is possible to produce laminates of the present invention by conventionally known methods. Examples thereof include using a vacuum laminator, using a vacuum bag, using a vacuum ring, using a nip roll, and the like. In addition, a method can be used in which, after temporary contact bonding, the resultant laminate is put into an autoclave for final bonding.

In the case of using a vacuum laminator, for example, a known instrument which is used for production of a solar cell can be used, and the assembly is laminated under a reduced pressure of about 1×10⁻⁶ MPa or more and about 3×10⁻² MPa or less at a temperature of about 100° C. or higher, or about 130° C. or higher, and about 200° C. or lower, or about 170° C. or lower. The method of using a vacuum bag or a vacuum ring is, for example, described in EP1235683A1 (CA2388107A1) and, for example, the assembly is laminated under a pressure of about 2× 10-2 MPa at about 130° C. or higher and about 145° C. or lower.

In the case of using a nip roll, for example, there is exemplified a method in which after conducting first temporary contact bonding at a temperature of a flow starting temperature of the skin resin or lower, temporary contact bonding is further conducted under a condition close to the flow starting temperature. Specifically, for example, there is exemplified a method in which the assembly is heated at about 30° C. or higher and about 100° C. or lower by an infrared heater or the like, then deaerated by a roll, and further heated at about 50° C. or higher and about 150° C. or lower, followed by conducting contact bonding by a roll to achieve bonding or temporary bonding.

Though the autoclave process which is supplementarily conducted after the temporary contact bonding is variable depending upon the thickness or constitution of a module, it is, for example, carried out under a pressure of about 1 MPa or more and about 15 MPa or less at a temperature of about 120° C. or higher and about 160° C. or lower for about 0.5 hours or more and about 2 hours or less.

Well-known “no-autoclave” processes may alternatively be used to process laminates.

Advantageously, the glass to be used for preparing a laminated glass is not particularly limited. Inorganic glasses, such as a float sheet glass, a polished sheet glass, a figured glass, a wired sheet glass, a heat-ray absorbing glass, and conventionally known organic glasses, such as polymethyl methacrylate and polycarbonate, and the like can be used. These glasses may be any of colorless, colored, transparent, or non-transparent glasses. These glasses may be used solely, or may be used in combination of two or more thereof.

The laminated glass of the present invention can be suitably used for a windshield for automobile, a side glass for automobile, a sunroof for automobile, a rear glass for automobile, or a glass for head-up display; a building member for a window, a wall, a roof, a sunroof, a sound insulating wall, a display window, a balcony, a handrail wall, or the like; a partition glass member of a conference room; a solar panel; and the like. Further information on such uses can be found by reference to the previously incorporated publications.

The invention will be further understood from the following specific examples. However, it will be understood that these examples are not to be construed as limiting the scope of the present invention in any manner.

### Examples

The glass used in the Examples was soda-lime glass, standard annealed (obtained from Guardian Industries, Inc., Galax VA, USA).

### Ionomer Sheet Preparation

For examples containing silane, the following approaches were utilized:

1200 grams of ionomer resin was weighed to the nearest 0.1 gram into a clean polypropylene plastic container (2 gallon capacity) with a large-mouth metal screw lid. The specific amount of liquid silane to yield the indicated concentration was pipetted into the container under proper ventilation and in line with proper laboratory safety practices. The container was then sealed with the lid and manually and thoroughly shaken for a period of 2 minutes to distribute the liquid over the mass of ionomer resin pellets. The mixture was shaken again after one hour from the initial preparation of the blend for a period of one minute and was shaken again for one minute prior to feeding the imbibed resin into the hopper of the feeder. The above operations were carried out under ambient temperature and humidity conditions (nominally 23 C and 50% RH, but not in a controlled humidity environment). Within about 4 hours of preparation, the silane/resin blend was fed into the extruder via a calibrated auger type feeder as described in the ionomer sheet preparation method below.

The ionomer resin was fed using a K-Tron feeder (Coperion GmbH) equipped with a calibrated pigtail type auger at about 5 to 7 lbs./hour into 18-mm diameter Liestritz twin-screw compounding extruder (screw speed set at 200 rpm) under the following temperature profiles provided in Table I and extruded into polymer strands (two 6-mm hole die).

The polymer throughput was controlled by adjusting the screw speed to provide for a given throughput or residence time and resultant shear condition. In both extruder cases, the melt strand was drawn through a water batch containing ambient temperature demineralized water, the excess water was blown off with compressed air and the strand fed into a rotating cutter (Conair) resulting in chopped strand pellets. These pellets were then dried overnight in a vacuum oven at 50° C. with a slight dry nitrogen purge. The pellets were then compression molded into nominal 0.76 mm thick plaques measuring 150-mm by 200-mm. These plaques were then maintained in a dry atmosphere, or where indicated, exposed to differing humidity conditions prior to lamination as provided below.

### Laminate Preparation Method

Glass laminates were prepared from each of the ionomer sheets by the following method. Annealed glass sheets (100×100×3 mm) were washed with a solution of trisodium phosphate (5 g/l) in de-ionized water at 50° C. for 5 min, then rinsed thoroughly with de-ionized water and dried. Three layers of each respective ionomer sheets (about 0.76 mm thick each) as listed in Table 1 were stacked together and placed between two lites of glass sheet (to yield an interlayer thickness of 2.28 mm).

The moisture level of the ionomer sheet was kept at or below 0.08% by weight by minimizing contact time to the room environment (about 35% RH) or was exposed for a period of 10 days (samples placed in an Espec Humidity chamber-Model LHU-113) at the temperature and humidity levels as indicated in the following examples.

The moisture level of the ionomer sheet was measured using a coulometric Karl Fischer method (Metrohm Model 800) with a heating chamber temperature of 150° C. for the sample vials. The ionomer sheeting was cut into small pieces to fit into the sample vials weighing a total of 0.40 grams.

The pre-lamination assembly was then taped together with a piece of polyester tape in a couple locations to maintain relative positioning of each layer with the glass lites. A nylon fabric strip was placed around the periphery of the assembly to facilitate air removal from within the layers. The assembly was placed inside a nylon vacuum bag, sealed and then a connection was made to a vacuum pump. A vacuum was applied to allow substantial removal of air from within (air pressure inside the bag was reduced to below 50 millibar absolute). The bagged assembly was then heated in a convection air oven to 120° C. and held for 30 min. A cooling fan was then used to cool the assembly down to near room temperature and the assembly was disconnected from the vacuum source and the bag removed yielding a fully pre-pressed assembly of glass and interlayer.

The assembly was then placed into an air autoclave and the temperature and pressure were increased from ambient to 135° C. at 13.8 bar over 15 min. This temperature and pressure was held for 30 min and then the temperature was decreased to 40° C. at a cooling of about 2.5° C./min whereby the pressure was then dropped back to ambient (over 15 min) and the final laminates were removed from the autoclave.

After the autoclave processing, the finished laminates were reheated in an air-circulating oven controlled at a temperature of 120° C.+/−2° C. and held for 2 to 3 hours to reach thermal equilibrium. Then, laminates were either slowly cooled at 0.1° C./min. to ambient temperature (˜ 23° C.), or quickly cooled (Quick) by removing the laminates from the 120° C. and cooling rapidly by forcing room temperature air across the face of each laminate by use of a large floor fan. A thermocouple placed within the ionomer interlayer and near the center of the laminate was used to determine the actual cooling rate curve of the sample. The temperature dropped from 120° C. to about 85° C. in 7 minutes and from 85° C. to 60° C. in 10 minutes and from 60° C. to 30° C. in 18 minutes and another 10 minutes brought the internal laminate temperature back to near room temperature. After these thermal cooling rate treatments of ‘Quick’ and 0.1° C./min (Slow) cooling, the optical measurements presented in Table 3 was developed.

### Haze, Clarity, and YI Measurement

The laminates were thoroughly cleaned using WINDEX glass cleaner (S.C. Johnson & Son, Inc.) and lintless cloths and were inspected to ensure that they were free of bubbles and other defects which might otherwise interfere with making valid optical measurements. The laminates were then evaluated by means of a Haze-gard Plus hazemeter (Byk-Gardner) to obtain a measurement of percent haze. The term “haze”, as used herein, refers to the percentage of transmitted light which in passing through a material deviates from the incident beam by greater than 2.5 degrees. Haze is measured according to ASTM Method No. D1003 (20000) using a Hazegard Plus hazemeter. The term “clarity”, as used herein, is related to the percentage of transmitted light which in passing through a material deviates from the incident beam; however, the angle of the deviation is less than 2.5 degrees. Clarity is also measured using a Hazegard Plus hazemeter.

Color, when measured, was made on a Hunterlab ULTRASCAN XE (Hunter Associates Laboratory, Inc., Reston, Va.) using 10 degree/D65 illuminant/observer. Yellowness index (YI) was calculated by ASTM E313-05, using a 2 degree observer and Illuminant C (2 degree).

TABLE 1
List of Polymers Used in this Work

| | Polymer | |
|---|---|---|
| Resin Code | Type | Description |
| PR-1 | Polystyrene | Ineos Styrolution (PS3600/3601) |
| PR-2 | PE | DuPont Alathon (20) |
| PR-3 | Nylon 66 | DuPont Zytel 101 |
| IO-1 | Sodium | a partially neutralized ethylene acid |
| | ionomer | dipolymer ionomer obtained from Dow |
| | | Chemical Co. (21.7% methacrylic acid, |
| | | Na 26% neutralized, MI = 1.8 |
| | | @190° C.) |
| IO-2 | Sodium | partially neutralized ethylene acid |
| | ionomer | terpolymer ionomer obtained from Dow |
| | | Chemical Co. (21.3% methacrylic acid, |
| | | 3.7% i-butyl methacrylate, Na 25% |
| | | neutralized, MI = 2.5 @190° C.) |
| IO-3 | Sodium | Recycle material comprising a partially |
| | ionomer | neutralized ethylene acid dipolymer |
| | recycle | ionomer obtained from Dow Chemical Co. |
| | | (21.7% methacrylic acid, Na 26% |
| | | neutralized, MI = 1.8 @190° C.) |
| IO-4 | Sodium | Recycle created from partially neutralized |
| | ionomer | ethylene acid terpolymer ionomer obtained |
| | recycle | from Dow Chemical Co. (21.3% methacrylic |
| | | acid, 3.7% i-butyl methacrylate, Na 25% |
| | | neutralized, MI = 2.5 @190° C.)); |
| | | containing ~750 ppm 3- |
| | | glycidoxypropylmethyldiethoxysilane as |
| | | formulated and subsequently processed into |
| | | sheeting by extrusion processing. |
| IO-5 | Sodium | a partially neutralized ethylene acid |
| | ionomer | ionomer obtained from Dow Chemical |
| | | Co. (19% methacrylic acid, sodium |
| | | neutralized 45%, MI = 4.5) |
| IO-6 | Sodium | a partially neutralized ethylene acid |
| | ionomer | dipolymer ionomer obtained from Dow |
| | | Chemical Co. (19% methacrylic acid, |
| | | sodium neutralized 37%, MI = 2.3) |
| ACR-1 | Nucrel* | ethylene acid dipolymer resin obtained |
| | 0411 | from Dow Chemical Co (4% methacrylic |
| | | acid copolymer, MI = 11) |
| ACR-2 | Nucrel* | ethylene acid dipolymer resin obtained |
| | 535 | from Dow Chemical Co (10.5% methacrylic |
| | | acid copolymer, MI = 33) |
| ACR-3 | Nucrel* | ethylene acid dipolymer resin obtained |
| | 925 | from Dow Chemical Co (15% methacrylic |
| | | acid copolymer, MI = 25) |

Table 2 presents optical data for laminates made from direct compression molding into plaques of resin pellets and their physical blends. Compression molding does not provide much mixing between adjacent resin particles and as such if there are differences in optical properties from one resin particle to another or even within each resin particle, these may be visible in the resulting polymer plaque or glass laminate made therefrom. The same two resins (IO-1 with IO-2) were introduced into a twin-screw extruder with reasonably intensive mixing capability, so that the resins were compounded together, striving for intimate blending. Examples CE2-01, CE2-02, CE2-03, and CE2-04 were neat resins. The blends EX2-01-EX2-07 were all visually clear on a ‘macroscale’ basis and the measured haze values for all laminated glass samples show relatively low haze values, but both clarity and visual distortion of physical blends showed a decrease in optical clarity from either of the starting point resins. This was due to the differences in refractive indices of the resins especially being apparent when physical mixtures are simply compression-molded and therefore not sufficiently mixed. The twin-screw extrusion compounded samples EX2-08 through EX2-10 were well-mixed, as determined by the visual distortion test and also the shadowgraph test. Visual distortion was evaluated by rating the magnitude of distortion of a ‘checkerboard’ (sized 12″×12″) of black and white square-grid (of 0.5-inch size), placing the grid at a distance of 12 feet distant from the laminated glazing (held vertically) and viewing at a distance of 4 feet from the subject glazing. The grid and the glazing were viewed in a normal perpendicular orientation and each glazing was assigned a number rating as follows: 0—none, 1—trace, 2—slight, 3—moderate, 4—heavy, 5—severe. Shadowgraph testing was performed using essentially the description provided in US patent application 2012-0133764. This resulted in a visual assessment of the non-uniformity image projected onto a retro-reflective screen.

TABLE 2

| | IO-1 with IO-2 | Haze | | # Visual |
|---|---|---|---|---|
| EXAMPLES | (wt. %) | (%) | Clarity | Distortion |
| COMPRESSION | | | | |
| MOLDED MIXTURES | | | | |
| CE2-01 | 0 | 0.41 | 99.60 | 0 |
| EX2-01 | 5 | 0.36 | 99.58 | 2 |
| EX2-02 | 10 | 0.43 | 99.53 | 3 |
| EX2-03 | 25 | 0.44 | 99.50 | 3 |
| EX2-04 | 50 | 0.51 | 99.35 | 5 |
| EX2-05 | 75 | 0.52 | 99.38 | 5 |
| EX2-06 | 90 | 0.69 | 99.35 | 4 |
| EX2-07 | 95 | 0.79 | 99.35 | 3 |
| CE2-02 | 100 | 0.68 | 99.48 | 1 |
| EXTRUSION | | | | |
| COMPOUNDED | | | | |
| CE2-03 | 0 | 0.71 | 99.65 | 0 |
| EX2-08 | 25 | 0.51 | 99.70 | 0 |
| EX2-09 | 50 | 0.50 | 99.70 | 0 |
| EX2-10 | 75 | 0.48 | 99.70 | 0 |
| CE2-04 | 100 | 0.58 | 99.65 | 0 |

Visual Distortion Rating:
0—none,
1—trace,
2—slight,
3—moderate,
4—heavy,
5—severe

In the subsequent tables of examples, a commensurate increase in haze with slow cooling was also apparent for all ionomer containing samples. It is well understood that ionomers of this family of compositions (ethylene-methacrylic acid copolymers and terpolymers as ionomers) possess some crystallinity and they also exhibit micro-phase-separation of polymer backbone and ionic clusters. These crystallites/ionic clusters then may cause visible light scattering (e.g. haze/lack of clarity) with the magnitude generally always increasing as the cooling rate decreases. During thermal processing of ionomer type interlayers into laminated glass form, general recommendations are to provide cooling from the ‘hot’ portion of the cycle (typically called ‘heat soak’ and at temperatures in the range of 105 C to 170 C) at a sufficient cooling rate to minimize the resulting haze formation due to the recrystallization and solidification process. As the ionomer interlayer cools from the melted state back to its ‘solid form’, the laminated glass is then stable and can be handled safely. Haze is an undesirable characteristic for glass laminates where high transparency is desired, therefore, faster cooling rates are also desirable. However, equipment limitations, adjustment of process settings and process conditions, differences in thermal heat transfer due to materials of construction and physical size/thickness, and so forth, will determine the actual rate of cooling that is typical or possible for glass laminates containing ionomer-based interlayers.

Table 3 includes compounded resins with relatively low levels (0.02% through 0.30% w/w) of a second resin which caused elevated haze and YID values, as well as elevated YID as compared with the neat resin (IO-1).

TABLE 3

| | | Cooling Rate | | |
|---|---|---|---|---|
| EXAMPLE | Description (wt. %) | (C/min.) | Haze (%) | YID |
| CE3-01 | IO-1 | Quick | 0.60 | 0.01 |
| CE3-02 | IO-1 | 0.1 | 4.58 | 1.21 |
| CE3-03 | IO-1 in 0.1% PR-1 | Quick | 34.45 | 12.26 |
| CE3-04 | IO-1 in 0.1% PR-1 | 0.1 | 35.94 | 12.86 |
| CE3-05 | IO-1 in 0.02% PR-1 | Quick | 1.87 | 1.88 |
| CE3-06 | IO-1 in 0.02% PR-1 | 0.1 | 5.50 | 2.82 |
| CE3-07 | IO-1 in 0.30% PR-2 | Quick | 4.97 | 0.76 |
| CE3-08 | IO-1 in 0.30% PR-2 | 0.1 | 7.17 | 1.47 |
| CE3-09 | IO-1 in 0.2% PR-3 | Quick | 2.21 | 3.71 |
| CE3-10 | IO-1 in 0.2% PR-3 | 0.1 | 20.58 | 15.65 |
| CE3-11 | IO-1 in 0.05% PR-3 | Quick | 1.09 | 1.11 |
| CE3-12 | IO-1 in 0.05% PR-3 | 0.1 | 16.73 | 12.59 |

Table 4 shows optical data for blends of IO-1 in various acid copolymer resins, each ranging in methacrylic acid levels from 4 wt. % to 15 wt. %. There is shown an apparent trend, that as the difference in acid levels decreased between the majority component (IO-1) and the added ACR resins, so did the magnitude of the haze and YID.

TABLE 4

| | | Cooling Rate | | |
|---|---|---|---|---|
| EXAMPLE | Description (wt. %) | (C/min.) | Haze (%) | YID |
| CE4-01 | IO-1 in 5% ACR-1 | Quick | 48.08 | 11.38 |
| CE4-02 | IO-1 in 5% ACR-1 | 0.1 | 49.55 | 8.92 |
| CE4-03 | IO-1 in 5% ACR-2 | Quick | 8.06 | 6.54 |
| CE4-04 | IO-1 in 5% ACR-2 | 0.1 | 8.55 | 6.53 |
| CE4-05 | IO-1 in 5% ACR-3 | Quick | 1.79 | 3.59 |
| CE4-06 | IO-1 in 5% ACR-3 | 0.1 | 3.59 | 5.84 |

Table 5 shows the haze and YID data for various combinations of blends of the following components: a). a virgin dicarboxylic acid ionomer (IO-1), b). a virgin ter-ionomer (IO-2), or each with their corresponding recycle resin forms, respectively IO-3 & IO-4. Normal and typical manufacturing operations would generally utilize a certain portion of the polymer resin that is extruded to be returned back into the process as recycle (internally derived). The compositional limits on the amount of recycle that would be appropriate to add would be related to the degree of impact on visible quality or to minimize any undesirable shifts in other performance parameters (e.g. tensile strength) that would result. Surprisingly, blends of the dicarboxylic acid (in either virgin resin and/or its corresponding recycle form) with the terpolymer (in either virgin resin and/or its corresponding recycle form) showed very good optical behavior with regard to haze and YID levels over the entire blend range. This would allow for complete flexibility in manufacturing to blend this resin family together with the finished product of such, providing acceptable optical consistency. Customers processing these blends could then expect uniform optical performance after laminating the sheet product comprising any blend ratio of said art even with differences in thermal cycles/cooling rates exhibited by their lamination process

TABLE 5

| | | Cooling Rate | | |
|---|---|---|---|---|
| EXAMPLE | Description (wt. %) | (C/min.) | Haze (%) | YID |
| CE5-01 | IO-1 in IO-2 (0:100) | 0.1 | 2.30 | −0.26 |
| EX5-01 | IO-1 in IO-2 (25:75) | 0.1 | 2.41 | −0.37 |
| EX5-02 | IO-1 in IO-2 (50:50) | 0.1 | 4.04 | 0.31 |
| EX5-03 | IO-1 in IO-2 (75:25) | 0.1 | 3.99 | 0.47 |
| CE5-02 | IO-1 in IO-2 (100:0) | 0.1 | 3.91 | 1.30 |
| CE5-03 | IO-1 in IO-2 (0:100) | Quick | 0.71 | −0.66 |
| EX5-04 | IO-1 in IO-2 (25:75) | Quick | 0.51 | −0.72 |
| EX5-05 | IO-1 in IO-2 (50:50) | Quick | 0.50 | −0.61 |
| EX5-06 | IO-1 in IO-2 (75:25) | Quick | 0.48 | −0.36 |
| CE5-04 | IO-1 in IO-2 (100:0) | Quick | 0.58 | −0.26 |

Table 6 provides optical data for combinations of the dicarboxylic acid ionomer (IO-1) and/or ter-ionomer (IO-2), or with their corresponding recycle versions and blends also including a 19% methacrylic acid copolymer based sodium ionomer (IO-6). These combinations showed a surprising optical effect, i.e., increases in haze and YID both occurred at intermediate compositional blends of IO-6. This can be seen in the series in Table 7 in which the haze progressively increased with the percent of IO-6 blended into IO-1 and IO-2, whereby the YID went through a maximum at intermediate values (c.f. EX6-03 where the YID is 4.07 versus either endpoint of 1.46 or 2.06 YID values). The same behavior can be seen for the example series where intermediate compositions containing IO-6 exhibited excessive YID values. Both of these trends were best seen in the slow cooling rate data at 0.1 C/min, but this behavior was also apparent in the ‘quick’ cooling rate data as well.

TABLE 6

| | | Cooling Rate | Haze | |
|---|---|---|---|---|
| EXAMPLE | Description (wt %) | (C/min.) | (%) | YID |
| EX6-01 | IO-1/IO-2/IO-6 (50:50:0) | 0.1 | 4.70 | 1.46 |
| EX6-02 | IO-1/IO-2/IO-6 (37.5:37.5:25) | 0.1 | 5.92 | 1.81 |
| EX6-03 | IO-1/IO-2/IO-6 (25:25:50) | 0.1 | 6.33 | 4.07 |
| EX6-04 | IO-1/IO-2/IO-6 (12.5:12.5:75) | 0.1 | 9.47 | 4.03 |
| CE6-01 | IO-1/IO-2/IO-6 (0:0:100) | 0.1 | 11.52 | 2.06 |
| EX6-05 | IO-1/IO-2/IO-6 (50:50:0) | Quick | 0.93 | 0.28 |
| EX6-06 | IO-1/IO-2/IO-6 (37.5:37.5:25) | Quick | 0.62 | 0.52 |
| EX6-07 | IO-1/IO-2/IO-6 (25:25:50) | Quick | 0.73 | 1.66 |
| EX6-08 | IO-1/IO-2/IO-6 (12.5:12.5:75) | Quick | 0.76 | 1.00 |
| CE6-02 | IO-1/IO-2/IO-6 (0:0:100) | Quick | 0.68 | 0.16 |
| EX6-09 | IO-4/I0-6 (25:75) | 0.1 | 6.01 | 3.35 |
| EX6-10 | IO-4/I0-6 (50:50) | 0.1 | 6.20 | 5.03 |
| EX6-11 | IO-4/I0-6 (75:25) | 0.1 | 6.11 | 3.35 |
| CE6-03 | IO-4/I0-6 (100:0) | 0.1 | 6.10 | 2.02 |
| EX6-12 | IO-4/I0-6 (25:75) | Quick | 0.76 | 1.31 |
| EX6-13 | IO-4/I0-6 (50:50) | Quick | 0.93 | 2.65 |
| EX6-14 | IO-4/I0-6 (75:25) | Quick | 0.53 | 1.26 |
| CE6-04 | IO-4/I0-6 (100:0) | Quick | 0.91 | 1.07 |

The above written description of the invention provides a manner and process of making and using it such that any person of ordinary skill in the relevant art is enabled to make and use the same, this enablement being provided in particular for the subject matter of the appended claims, which make up a part of the original description. This description is provided in the context of a particular application and its requirements. Various modifications to the embodiments will be readily apparent to those of ordinary skill in the relevant art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein. In this regard, certain embodiments within the invention may not show every benefit of the invention, considered broadly.

1. An ionomer resin composition comprising:
(i) from about 1 wt % to about 99 wt % of an at least partially sodium-neutralized ethylene acid dipolymer ionomer resin, and
(ii) from about 1 wt % to 99 wt % of an at least partially sodium-neutralized ethylene acid ester terpolymer ionomer resin,
wherein the combined wt % of (i) and (ii) is 100 wt %, and wt % is based on the combined weight of (i)+ (ii).

2. The composition of claim 1, wherein the dipolymer ionomer resin is an at least partially sodium-neutralized ethylene acid dipolymer ionomer resin consisting essentially of copolymerized units of ethylene and at least one α,β-unsaturated carboxylic acid, and the terpolymer ionomer resin is an at least partially alkali metal-neutralized ethylene acid terpolymer ionomer resin comprising copolymerized units of ethylene, at least one α,β-unsaturated carboxylic acid, and at least one α,β-unsaturated carboxylic acid ester.

3. The composition of claim 1, further comprising a dialkoxysilane adhesion promoter present in the ionomer resin composition in an amount ranging from about 50 to about 5000 parts per million by weight based on the combined weight of the dipolymer and terpolymer ionomer resins.

4. The ionomer resin composition of claim 1,
wherein the dipolymer ionomer resin consists essentially of copolymerized units of:
(i) ethylene, and
(ii) from about 10 wt % to about 30 wt % of at least one α,β-unsaturated carboxylic acid having 3 to 10 carbon atoms,
wherein the weight percentages of the copolymerized units of the dipolymer ionomer resin are based on the total weight of the dipolymer ionomer resin and the sum of the weight percentages of the dipolymer ionomer resin's copolymerized units is 100 wt %, and wherein at least a portion of the dipolymer ionomer resin's carboxylic acid groups of the α,β-unsaturated carboxylic acid are neutralized to form an ionomer comprising carboxylate groups having sodium counterions, and
wherein the terpolymer ionomer resin consists essentially of copolymerized units of:
(i) ethylene,
(ii) from about 10 wt % to about 30 wt % of at least one α,β-unsaturated carboxylic acid having 3 to 10 carbon atoms,
(iii) from about 2 wt % to about 15 wt % of at least one α,β-unsaturated carboxylic acid ester having 3 to 10 carbon atoms, and
(iv) optionally a derivative of an α,β-unsaturated carboxylic acid other than (iii) in an amount such that (iii)+ (iv) is about 15 wt % or less,
wherein the weight percentages of the copolymerized units of the terpolymer ionomer resin are based on the total weight of the terpolymer ionomer resin and the sum of the weight percentages of the terpolymer ionomer resin's copolymerized units is 100 wt %, and wherein at least a portion of the terpolymer ionomer resin's carboxylic acid groups of the α,β-unsaturated carboxylic acid are neutralized to form an ionomer comprising carboxylate groups having sodium counterions.

5. The ionomer resin composition of claim 1, wherein a weight ratio of the dipolymer ionomer resin to the terpolymer ionomer resin, w/w dipolymer/terpolymer, in the composition, based on total weight of the dipolymer and terpolymer ionomer resins, is 1/99-50/50.

6. The ionomer resin composition of claim 1, wherein a weight ratio of the dipolymer ionomer resin to the terpolymer ionomer resin, w/w dipolymer/terpolymer, in the composition, based on total weight of the dipolymer and terpolymer ionomer resins, is 99/1-50/50.

7. The ionomer resin composition of claim 1, wherein one of (i) or (ii) is from about 5 wt % to about 30 wt %, based on the combined weight of (i)+ (ii).

8. The ionomer resin composition of claim 7, wherein one of (i) or (ii) is from about 10 wt % to about 30 wt %, based on the combined weight of (i)+ (ii).

9. The ionomer resin composition of claim 7, wherein one of (i) or (ii) is from about 5 wt % to about 25 wt %, based on the combined weight of (i)+ (ii).

10. The ionomer resin composition of claim 7, wherein one of (i) or (ii) is from about 10 wt % to about 25 wt %, based on the combined weight of (i)+ (ii).

11. The ionomer resin composition of claim 1, wherein at least a portion of at least one of (i) and (ii) is in the form of a recycle material.

12. The ionomer resin composition of claim 11, wherein substantially all of (i) or (ii) is a recycle material.

13. The ionomer resin composition of claim 1, wherein at least a portion of one of (i) or (ii) is in the form of a virgin material.

14. The ionomer resin composition of claim 1, wherein at least a portion of at least one of (i) and (ii) is a combination of virgin material and recycle material.

15. The ionomer resin composition of claim 1, wherein both of (i) and (ii) is a combination of virgin material and recycle material.

16. The ionomer resin composition of claim 1, wherein one of (i) or (ii) is substantially a virgin material, and one of (i) and (ii) is a combination of virgin material and recycle material.

17. The ionomer resin composition of claim 1, wherein one of (i) or (ii) is substantially a virgin material, and one of (i) or (ii) is substantially a recycle material.

18. An interlayer sheet comprising the ionomer resin composition of claim 1.

19. A glass laminate, comprising the interlayer sheet of claim 18.

20. A method of producing an interlayer sheet as set forth in claim 18, comprising the step of melt blending (i), (ii) and optional components under shear to produce a melt blend, then extruding the melt blend through a die into a sheet form, then cooling the sheet form to solidify the resin composition.
